(19) United States
(12) Patent Application Publication
(10) Pub. No.: US 2016/0171061 A1
(43) Pub. Date: Jun. 16, 2016

(54) SYSTEM AND METHOD FOR PRODUCT MANAGEMENT, SUPPORT AND SERVICING

(71) Applicant: Caterpillar Global Nining LLC, Oak Creek, WI (US)

(72) Inventor: Anshu Srivastava, Shorewood, WI (US)

(73) Assignee: Caterpillar Global Mining LLC, Oak Creek, WI (US)

(21) Appl. No.: 15/051,692

(22) Filed: Feb. 24, 2016

(51) Int. Cl. G06F 17/30; G06Q 10/00

(52) U.S. Cl. CPC G06F 17/30554; G06Q 10/20; G06F 17/30557

(57) ABSTRACT

A system for providing product management services is provided. The system includes a client, a server, an application, a database and a communication network. The client is configured to run the application, where the application offers a user interface to receive a query from a user related to at least one product. The query includes a plurality of identification attributes of the at least one product. The server is operatively coupled with the client and is configured to process the query related to the at least one product. The server is coupled with the database, where the database stores information of the at least one product. The information includes a plurality of characteristics of the at least one product and a machine. The server receives the query from the client over the communication network. The server is configured to render the information to the user using the application.

### TECHNICAL FIELD

The present disclosure relates to product management, support and servicing systems, and more specifically, to a system and method for providing end to end product management, such as product ordering, installation, and servicing of the product via an application.

### BACKGROUND

In a day to day operation, an operator needs time as well as effort to manually check the availability of a part (also called product) in a store or with a supplier. The operator needs to review product installation guide for a proper replacement of damaged parts within a machine. All such procedures are cumbersome, inefficient and cost ineffective.

Currently, various applications (also called app) are used for accessing product information for quick guidance on the product installation and maintenance support. However, such applications need the operator to manually feed a part identification code or a keyword to search for part availability. The operator needs to remember the part identification code or need to input keywords for hit and trial search that returns inappropriate results and becomes a time taking procedure.

U.S. Pat. No. 8,082,076, hereinafter referred to as '076 reference, discloses a visual diagnostic system. The visual diagnostic system has a sensor located onboard a machine to generate a signal indicative of a status of a machine component, and a user interface associated with the machine to receive input from and provide information to a user. The visual diagnostic system also has a controller in communication with the sensor and the user interface. The controller is configured to display on the user interface a model containing the machine component in response to the signal. However, the '076 reference fails to disclose an application that returns required information by entering a query related to a product, or a part/component of the machine. Therefore, there is a need for a system and method for fetching required information about the product or part for a quick access and also offer easy installation of the part via an application.

### SUMMARY OF THE DISCLOSURE

In one aspect of the present disclosure, a system for providing product management services is provided. The system includes a client, a server, an application, a database and a communication network. The client is configured to run the application, where the application offers a user interface to receive a query from a user related to at least one product. The query includes a plurality of identification attributes of the at least one product. The server is operatively coupled with the client and is configured to process the query related to the at least one product. The server is coupled with the database, where the database stores information of the at least one product. The information includes a plurality of characteristics of the at least one product and a machine. The server receives the query from the client over the communication network. The server is configured to render the information to the user using the application.

Other features and aspects of this disclosure will be apparent from the following description and the accompanying drawings.

### BRIEF DESCRIPTION OF THE DRAWINGS

FIG. 1 is an environment utilizing a system, according to the concepts of the present disclosure;

FIG. 2 is a block diagram of the system for providing product management, support and servicing, according to the concepts of the present disclosure;

FIG. 3 depicts a user interface rendered on a client via an application, according to the concepts of the present disclosure; and

FIG. 4 is a flowchart of a method for providing product management, support and servicing, according to the concepts of the present disclosure.

### DETAILED DESCRIPTION

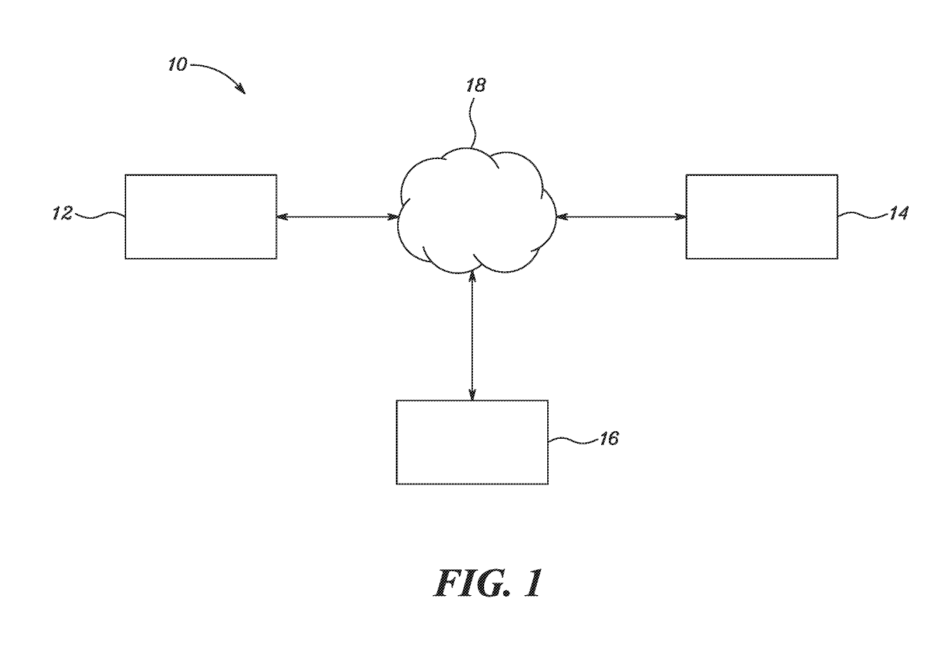

Referring to FIG. 1, a system 10 includes a client 12, a server 14, and a database 16 and each is operatively coupled with each other via a communication network 18. The client 12 and the server 14 share the database 16 for exchange of information.

The communication network 18 includes a communication system that connects computers (or devices) by wire, cable, fiber optic and/or wireless link facilitated by various types of well-known network elements, such as hubs, switches, routers. The communication network 18 is a part of the Intranet using various communications infrastructure, such as Ethernet, Wi-Fi, a Personal Area Network (PAN), a wireless PAN, Bluetooth, Near Field Communication (NFC).

A user (or an operator) operates the client 12 to input a query for receiving the information with respect to the query. The client 12 is a type of computing device (e.g., a Personal Digital Assistant (PDA), a tablet, a smart phone, a laptop). The server 14 receives the query from the client 12 and in return fetches the information matching with the query from the database 16. The information is returned to the user via the user interface (UI) 32 of the client 12.

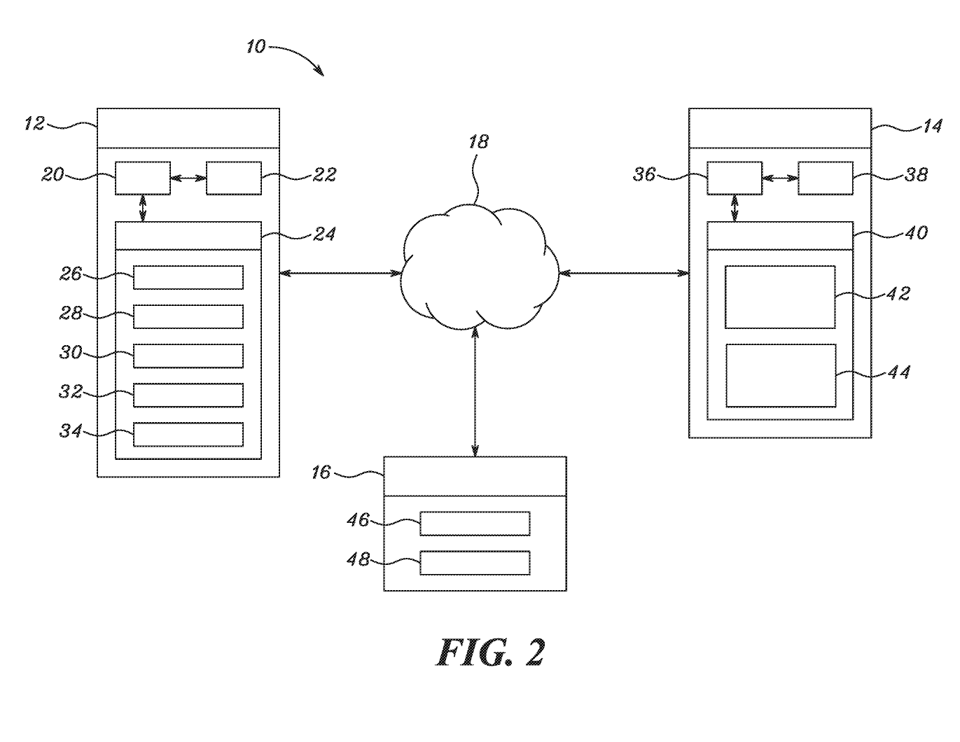

Referring to FIG. 2, the client 12 includes a central processing unit (CPU) 20, support circuits 22, and a memory 24. The memory 24 includes an operating system (OS) 26, a communication module 28, an application 30 (also called as app), the user interface (UI) 32 and an input/output (I/O) module 34. The client 12 runs the operating system 26 for managing the client 12 hardware and software resources and provides common services. The application 30 requires the operating system 26 to function appropriately. The CPU 20 includes one or more commercially available microprocessors or microcontrollers that facilitate data processing and storage. The support circuits 22 facilitate the operation of the CPU 20 and include one or more clock circuits, power supplies, cache, input/output circuits, and displays. The memory 24 includes Read Only Memory (ROM), Random Access Memory (RAM), disk drive storage, optical storage, removable storage. It will be apparent to the one skilled in the art that the application 30 is installed on the client 12 and/or on the server 14 as desired without departing from the meaning and scope of the present disclosure.

In an embodiment, the server 14 includes a central processing unit (CPU) 36, support circuits 38, and a memory 40. The CPU 36 includes one or more commercially available microprocessors or microcontrollers that facilitate data processing and storage. The support circuits 38 facilitate the operation of the CPU 36 and include clock circuits, power supplies, cache, input/output circuits, and displays. The memory 40 includes an identifying module 42 and a matching module 44.

In an embodiment, the database 16 stores an information 46 related to a product (or a component) and a machine. The information 46 includes information processing on multiple databases (i.e. the database 16) in cloud to generate new information/aggregate information/do calculations and create new results in new databases (i.e. the database 16). Support diagnostic, prescriptive and predictive analytics related to the part 60 or machine in the query, and fetch these analysis results to the user. The information 46 also includes establishing a text/voice/video bi-directional communication between the user and an artificial intelligent machine/agent or a live person(s) to provide the user with real time assistance on the query. The database 16 applies an indexing format on the information 46 for sorting the information 46 in tables 48. Such indexing is performed to search and return the information 46 to the client 12. The information 46 includes a number of characteristics of the product, the machine, a part 60 within the machine. The characteristics include, but are not limited to, a three dimensional model of the product, a three dimensional model of the machine, location of the product/part within the machine, installation procedure of the product/part in the machine, maintenance and service schedule, availability of the product in a warehouse or a store or a supplier, an order status, and other information. It will be apparent to the one skilled in the art that the database 16 stores the information 46 in any suitable format, such as an image, a sound format, audio and/or video related to the product without departing from the meaning and scope of the disclosure. It will be apparent to the one skilled in the art that the database 16 resides on the server 14 or at any other location coupled to the communication network 18 without departing from the meaning and scope of the disclosure.

In an embodiment, the application 30 running on the client 12 renders the user interface 32 that provides the user with an interactive communication with the application 30. The application 30 allows the user to input the query related to the product (or the machine or a component of the machine) via the input/output module 34 of the client 12. The input/output module 34 includes, but is not limited to a keypad, a camera, a speaker, a microphone, a touch keypad, or any other sensing device to receive the query from the user. The user inputs the query to fetch the information 46. The query includes a number of identification attributes of the product that helps in identifying the product. The query includes, but is not limited to, scanned information of the product (or the part 60 or the machine), a digital image of the product; a product identification code, a barcode, a quick response (QR) code, a keyword describing the product characteristics, a radio frequency identification (RFID) code, and an audio input describing the product or any other product identifying information.

After generating the query on the client 12, the client 12 implements the communication module 28 to send the query to the server 14 via the communication network 18. In an embodiment, the communication module 28 includes a transceiver for performing two way communication with the server 14.

The server 14 receives and processes the query for recognizing and classifying the identification attributes of the product via the identifying module 42. The server 14 is in communication with the database 16 to fetch the information 46 that matches with the query. For fetching the information 46, the server 14 searches through the information 46 arranged in the tables 48 in the database 16. The server 14 implements the matching module 44 to match the identification attributes in the query with the information 46 in the database 16. As a result, the information 46 matching with the query is fetched from the database 16 and is returned to the client 12. The user is able to view the information 46 on the UI 32 of the client 12.

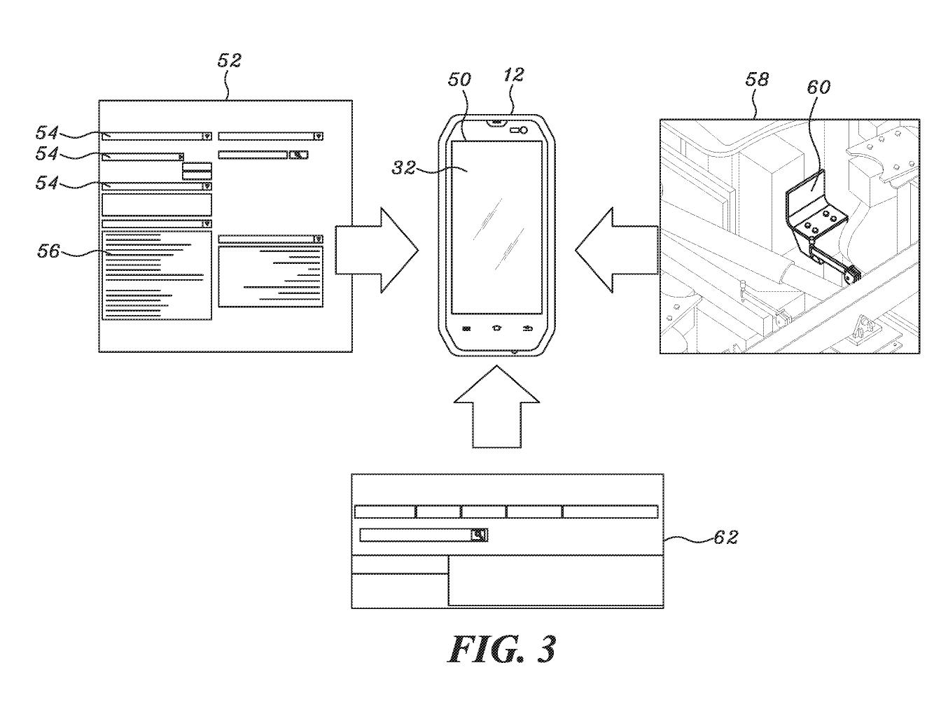

Referring to FIG. 3, the client 12 includes a display 50 that displays the user interface 32 for carrying out various operations. After entering the query via the user interface 32, the server 14 returns the information 46 to the client 12. The information 46 includes the three dimensional model of the product, or the machine or the part 60 of the machine or machine configuration, a technical guide 52 related to the product, a store information 62 showing the availability of the product, a maintenance schedule or procedures, a service schedule of the product, an audio and/or video guide, a step wise readable procedure, or a link to other web access resource, and any other information for helping the user (or the operator).

Referring to the FIG. 3, the technical guide 52 is accessed using the user interface 32. The technical guide 52 includes a number of menus 54 that includes a number of data 56. The user selects the data 56 to access or view the information related to the data 56. The technical guide 52 includes and is not limited to installation procedure of the product, product and machine specifications, maintenance procedures, spare part information, warranty periods of the products. Also, a three dimensional image 58 of the machine and attached part/product is available on the display 50 of the client 12. The three dimensional image 58 shows location of the part 60 inside the machine. Hence, the user is able to know the exact location of the part 60 in three dimensional coordinates inside the machine. In addition, the server 14 returns the store information 62 (also the information 46) of the product. The store information 62 shows availability of the product, price of the product and any other information related to the product. It will be apparent to the one skilled in the art that the system 10 is able to return any other information stored in the database 16 at the client 12 other than the technical guide 52, the three dimensional image 58, the store information 62 without departing from the meaning and scope of the present disclosure.

### INDUSTRIAL APPLICABILITY

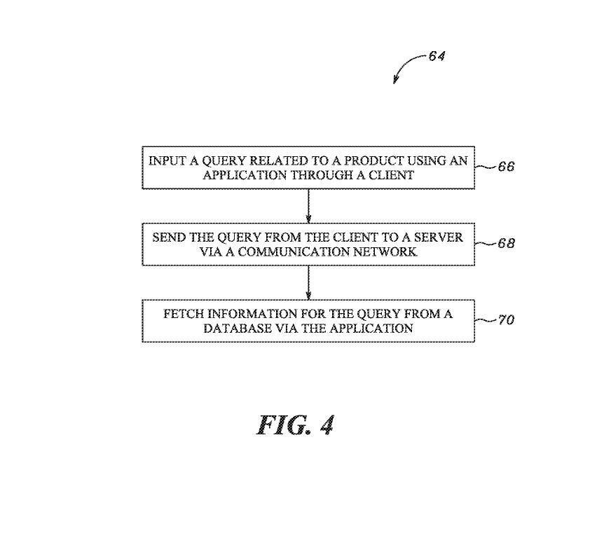

Referring to FIG. 4, a method 64 is described in conjunction with the FIGS. 1-3.

At step 66, the user enters the query related to the product (or the machine, or the part 60 in the machine) using the application 30 in the client 12 for accessing the information 46.

At step 68, the client 12 sends the query to the server 14 via the communication network 18. The server 14 receives the query.

At step 70, the server 14 communicates with the database 16 and matches the query with the information 46 in the database 16. Thereafter, the server 14 fetches the information 46 that matches with the query from the database 16. After fetching the information 46, the server 14 returns the information 46 to the client 12 and the user accesses the information 46.

The system 10 of the present disclosure supports the application 30 at the client 12 that provides end to end solutions to the user for product management, support and servicing without the need of manually going through the technical guides (i.e. the technical guide 52 shown in FIG. 3). The application 30 allows the user to enter the product related query that includes scanning of the product or the part 60 or part packaging, or taking an image of the product using the client 12. Advantageously, the application 30 provides an efficient and accurate way to enter the query apart from the conventional way of manually feeding the query. The application 30 sends the scanned image to the server 14 for receiving the desired information.

The application 30 helps in locating where the part 60 is used on the machine by providing a three dimensional model showing inner and outer configuration of the machines. Also, the application 30 provides the installation procedure of the part 60 within the machine. For example, the application 30 provides installation instructions, installation tools, torque, specifications of the part 60 or the machine. Further, the application 30 provides troubleshooting of the product or part along with performance information of the product. Further, the application 30 also provides manufacturing details of the product, such as dates, serial number, warranty status. Furthermore, the user is also able to check the availability of the product and if desires, the user is able to place an order through the application 30. Information regarding a replaceable product is also accessed through the application 30. The application 30 also provides order status, such as delivery time, delivery date, and address.

Additionally, the application 30 provides historical data including performance logs of the product, when was the product replaced or maintained. The application 30 is also able to render the information about service repair parts. In case the product is an inventory part, the application 30 shows age of the inventory, any profit or operating costs involved with the product. If the part has been obsolete, superseded or is a quality reject, then the application 30 provides and updates status in real-time. For product maintenance, the application 30 informs about the types of parts installed in different machines, and the related jobs of the product with repairing jobs.

Therefore, the application 30 provides an intelligent solution for making the product a live and communicating one that carries digital information along with it, hence adding more value to the product. Consequently, just by scanning the product or taking an image of the product, the application 30 returns desired information related to the product. This avoids the need of carrying manual and cumbersome guides with every product. All information related to the product is accessible at the client 12 just by scanning the product or the part 60, part packaging or taking image.

Resultantly, the application 30 provides an easier, quicker and interactive way to access information related to the product over the communication network 18.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A system for providing product management services, the system comprising:
a client configured to run an application, the application offers a user interface to receive a query from a user related to at least one product; the query includes a plurality of identification attributes of the at least one product; and
a server operatively coupled with the client and is configured to process the query related to the at least one product, the server is coupled with a database, the database stores information of the at least one product, the information includes a plurality of characteristics of the at least one product and a machine;
wherein the server receives the query from the client over a communication network, the server is configured to render the information to the user using the application.
